(19) United States
(12) Patent Application Publication
(10) Pub. No.: US 2018/0247242 A1
(43) Pub. Date: Aug. 30, 2018

(54) METHOD OF GENERATING A TASK PLAN, INFORMATION PROCESSING APPARATUS AND NON-TRANSITORY COMPUTER-READABLE STORAGE MEDIUM

(71) Applicant: FUJITSU LIMITED, Kawasaki-shi (JP)

(72) Inventors: Jun FUKAO, Ichinomiya (JP); Masanori SAKAI, Nagoya (JP); Yukinori Hayashi, Osaka (JP); Tatsuya ISHIHARA, Yokohama (JP)

(73) Assignee: FUJITSU LIMITED, Kawasaki-shi (JP)

(21) Appl. No.: 15/882,585

(22) Filed: Jan. 29, 2018

(30) Foreign Application Priority Data
Feb. 28, 2017 (JP) 2017-036629

(51) Int. Cl. G06Q 10/06; G06Q 50/04

(52) U.S. Cl. CPC G06Q 10/06312; G06Q 50/04; G06Q 10/06395

(57) ABSTRACT

A method of generating a task plan that defines a plurality of execution times of a plurality of tasks by using a computer, the method includes acquiring attribute information indicating a plurality of attributes of the plurality of tasks when the task plan is generated so that the plurality of tasks are executed within a first time period, and executing, based on the acquired attribute information, a determination process that determines the plurality of execution times of the plurality of tasks so that a plurality of attribute values of the plurality of attributes of the plurality of tasks increase or decrease as time passes within the first time period.

### CROSS-REFERENCE TO RELATED APPLICATION

This application is based upon and claims the benefit of priority of the prior Japanese Patent Application No. 2017-36629, filed on Feb. 28, 2017, the entire contents of which are incorporated herein by reference.

### FIELD

The embodiment discussed herein is related to a method of generating a task plan, an information processing apparatus and a non-transitory computer-readable storage medium.

### BACKGROUND

For a task plan or, for example, a plan of producing products, a method of efficiently generating a plan of producing products by causing a device such as a server to assign time and dates when production lines are used to task information items of production tasks based on the availability of the production lines, the order of production tasks, or the like is known. Hereinafter, a “production line” is merely referred to as “line” in some cases. As related-art documents, there are Japanese Laid-open Patent Publications Nos. 3-32556 and 2004-145880.

### SUMMARY

According to an aspect of the invention, a method of generating a task plan that defines a plurality of execution times of a plurality of tasks by using a computer, the method includes acquiring attribute information indicating a plurality of attributes of the plurality of tasks when the task plan is generated so that the plurality of tasks are executed within a first time period, and executing, based on the acquired attribute information, a determination process that determines the plurality of execution times of the plurality of tasks so that a plurality of attribute values of the plurality of attributes of the plurality of tasks increase or decrease as time passes within the first time period.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a system according to an embodiment;

FIG. 2 is a block diagram illustrating an example of a hardware configuration of a server;

FIGS. 3A, 3B and 3C are diagrams illustrating an example of order scheduling according to the embodiment;

FIGS. 4A and 4B are diagrams describing an example of a switching task in the case where tasks are executed on products with different thicknesses;

FIG. 5 is a diagram illustrating a display example of an arrangement pattern selection screen;

FIG. 6 is a diagram illustrating an example of a data configuration of stage information;

FIG. 7 is a diagram illustrating an example of a data configuration of production plan information;

FIG. 8 is a diagram describing an example of a process related to control executed by a controller to assign time and dates to task information items;

FIG. 9 is a diagram illustrating an example of a data configuration of line resource information;

FIG. 10 is a diagram illustrating an example of a data configuration of line production procedure information;

FIG. 11 is a diagram illustrating an example of a data configuration of product information;

FIG. 12 is a diagram illustrating an example of a data configuration of arrangement plan information;

FIG. 13 is a diagram illustrating an example in which time and dates are assigned to tasks arranged in various types of order based on sort patterns;

FIG. 14 is a flowchart of an example of operations of the server according to the embodiment;

FIG. 15 is a flowchart of an example of operations of the server according to the embodiment;

FIGS. 16A and 16B are diagrams illustrating order scheduling according to a modified example of the embodiment;

FIG. 17 is a diagram illustrating an example of a data configuration of switching time period information;

FIG. 18 is a diagram illustrating an example of a switching matrix; and

FIG. 19 is a flowchart of operations of the server according to the modified example of the embodiment.

### DESCRIPTION OF EMBODIMENT

In the generation of a production plan by a server, production tasks are arranged in such a manner that time periods for executing the tasks are within operating time of a production line in consideration of the time periods for executing the production tasks and the like.

In the line, the efficiency of a task of switching between production tasks may be improved depending on a combination of preceding and succeeding production tasks in some cases, and the task of switching between the production tasks may be facilitated depending on the combination in some cases. In the aforementioned method, however, time and dates are not assigned to multiple task information items in consideration of a combination of preceding and succeeding production tasks in order to improve the efficiency of the switching task and facilitate the switching task.

Examples of the switching task are a task of cleaning the line and a task of replacing a jig with another jig. The switching task may be referred to as stage switching task and treated as an accessory task for the production tasks.

Hereinafter, an embodiment is described with reference to the accompanying drawings. The embodiment described below is an example and does not intend to exclude the application of various modifications and techniques that are not explicitly mentioned in the following description. For example, the embodiment may be modified in various manners and achieved without departing from the gist of the embodiment. In the drawings to be used in the following embodiment, sections that are indicated by the same reference symbol are the same or similar to each other, unless otherwise stated.

### [1] Embodiment

### [1-1] Example of Configuration of System

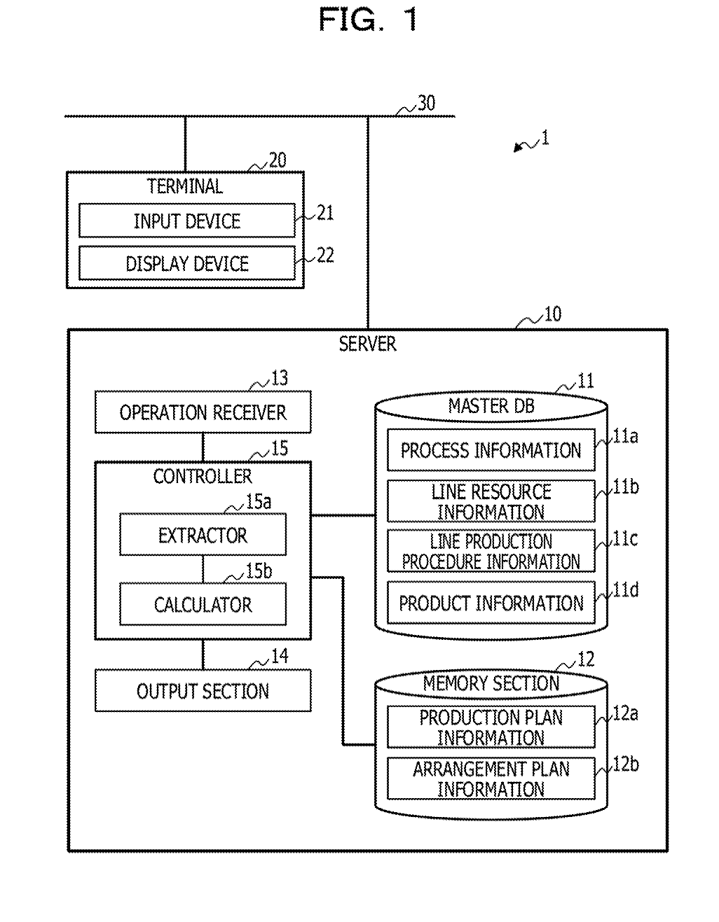

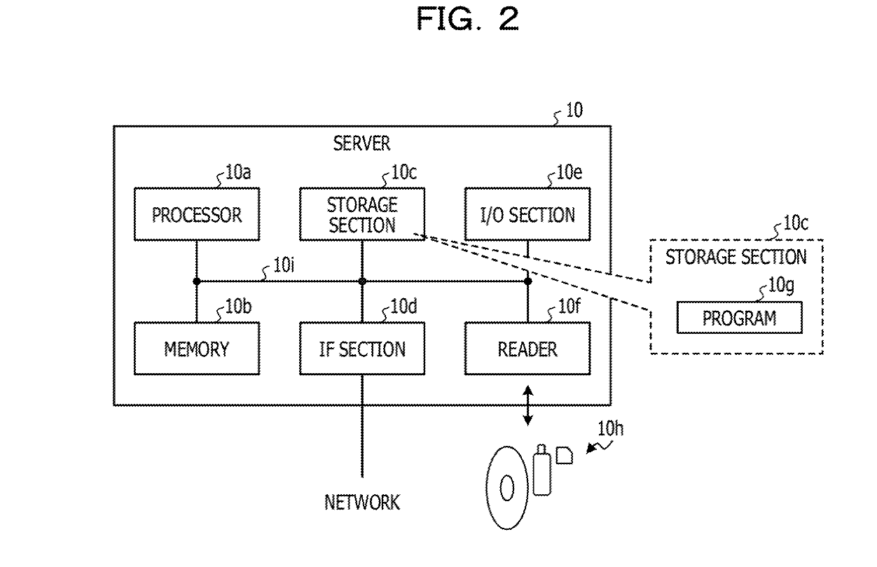

FIG. 1 is a block diagram illustrating an example of a functional configuration of a system 1 according to the embodiment, while FIG. 2 is a block diagram illustrating an example of a hardware configuration of a server 10.

As illustrated in FIG. 1, the system 1 may exemplarily include the server 10 and a terminal 20. Multiple terminals 20 may be included in the system 1.

The server 10 is an example of a task plan generating device. The server 10 may execute a process related to the generation of a task plan in response to access from the terminal 20 and give a response indicating results of the process to the terminal 20, thereby causing the terminal 20 to display the task plan.

The terminal 20 is an example of a terminal device and may be treated as a client of the server 10. As illustrated in FIG. 1, the terminal 20 may exemplarily include an input device 21 and a display device 22. The terminal 20 may access the server 10 via an operation of the input device 21 by an operator and display the response (process results) from the server 10 in the display device 22.

Communication between the terminal 20 and the server 10 may be inter-application communication between a client application of the terminal 20 and a server application of the server 10. The communication may include communication between a web browser of the terminal 20 and a web server of the server 20 via the Hypertext Transfer Protocol (HTTP) or the like.

The server 10 and the terminal 20 may be coupled to and able to communicate with each other via a network 30 including either or both of a wired network and a wireless network. Examples of the network 30 are networks conforming to standards such as Ethernet (registered trademark) and InfiniBand.

(Example of Hardware Configuration)

Next, an example of a hardware configuration of the server 10 is described. The terminal 20 may have the same hardware configuration as that of the server 10. The example of the hardware configuration of the server 10 is described as a representative of the server 10 and the terminal 20.

As Illustrated in FIG. 2, the server 10 as an example of a computer or as an example of an information processing device may exemplarily include a processor 10a, a memory 10b, a storage section 10c, an interface (IF) section 10d, an input and output (I/O) section 10e, and a reader 10f.

The processor 10a is an example of an arithmetic processing unit that executes various types of control and computation. The processor 10a may be coupled to and able to communicate with the blocks 10b to 10f via a bus 10i. As the processor 10a, an integrated circuit (IC) such as a CPU, a GPU, an MPU, a DSP, an ASIC, or a PLD (for example, an FPGA) may be used. CPU stands for Central Processing Unit. GPU stands for Graphics Processing Unit. MPU stands for Micro Processing Unit. DSP stands for Digital Signal Processor. ASIC stands for Application Specific Integrated Circuit. PLD stands for Programmable Logic Device. FPGA stands for Field Programmable Gate Array.

The memory 10b is an example of hardware that stores various types of data and programs. As the memory 10b, a volatile memory or, for example, a RAM such as a dynamic RAM may be used. RAM stands for Random Access Memory.

The storage section 10c is an example of hardware that stores various types of data and programs. For example, the storage section 10c may be used as a secondary storage device of the server 10 and may store programs such as an operating system (OS), firmware, and applications, and various types of data. Examples of the storage section 10c are various storage devices including a magnetic disk device such as a hard disk drive (HDD), a semiconductor driving device such as a solid state drive (SSD), and a nonvolatile memory. Examples of the nonvolatile memory are a flash memory, a storage class memory (SCM), and a read only memory (ROM). The storage section 10c may store a program 10g that achieves all or a part of various functions of the server 10.

The IF section 10d is an example of a communication interface that controls the coupling between the server 10 and the terminal 20 via the network and controls communication between the server 10 and the terminal 20 via network 30. An example of the IF section 10d is an adapter conforming to Ethernet (registered trademark), InfiniBand, or the like. The server 10 may include a communication interface that controls the coupling between the server and a managing terminal of an administrator and controls communication between the server 10 and the managing terminal. The server 10 may use this communication interface to download the program 10g from a network (not illustrated).

The I/O section 10e may include either or both of an input device such as a mouse, a keyboard, a touch panel, or an operational button and an output device such as a display, a projector, or a printer, for example. For example, the Input device 21 of the terminal 20 illustrated in FIG. 1 is an example of the input device of the I/O section 10e, while the display device 22 is an example of the output device of the I/O section 10e.

The reader 10f is an example of a reader that reads data stored in a recording medium 10h and a program stored in the recording medium 10h and outputs the data and the program to the processor 10a. The reader 10f may include a coupling terminal to which the recording medium 10h is able to be coupled or into which the recording medium 10h is able to be inserted. Examples of the reader 10f are an adapter conforming to a Universal Serial Bus (USB) device or the like, a driving device that accesses a recording disk, and a card reader that accesses a flash memory such as an SD card. The program 10g and the like may be stored in the recording medium 10h.

Examples of the recording medium 10h are non-transitory computer-readable recording media such as a magnetooptical disc and a flash memory. Examples of the magnetooptical disc are a flexible disk, a compact disc (CD), a digital versatile disc (DVD), a Blu-ray disc, and a holographic versatile disc (HVD). Examples of the flash memory are semiconductor memories such as a USB memory and an SD card. Examples of the CD are a CD-ROM, a CD-R, and a CD-RW. Examples of the DVD are a DVD-ROM, a DVD-RAM, a DVD-R, a DVD-RW, a DVD+R, and a DVD+RW.

The aforementioned hardware configuration of the server 10 is an example. Thus, hardware (for example, an arbitrary block) may be added to the hardware within the server 10, a portion (for example, an arbitrary block) of the hardware within the server 10 may be removed, the hardware within the server may be divided, portions or arbitrary blocks of the hardware within the server may be combined, a bus may be added to the hardware within the server 10, a bus included in the hardware within the server 10 may be omitted, and the like.

(Brief Description of Method of Arranging Task Information Items According to Embodiment)

Next, a method of arranging task information items according to the embodiment is briefly described.

The server 10 generates the task plan by assigning time and dates to task information items. An example of the task plan is a production plan of the processing, assembly, and the like of products in a factory. As the task plan, the production plan is described below as an example.

As described above, in the generation of the production plan, the efficiency of a switching task may be improved depending on a combination of preceding and succeeding production tasks arranged in a line in some cases, or the switching task may be facilitated depending on the combination of preceding and succeeding production tasks arranged in the line in some cases.

The improvement of the efficiency of the switching task and the facilitation of the switching task are caused by various factors. One of the factors is differences between attribute values of attribute information of multiple products handled in multiple tasks. Examples of the “attribute information” are information on “color densities”, “temperatures”, and “sizes”. Examples of the “attribute values” are values indicating the “color densities”, the “temperatures”, and the “sizes”. The “temperatures” may be “temperature zones”, for example. Examples of the “sizes” are “widths” and “thicknesses”.

In the embodiment, the server 10 flexibly assigns (for example, executes optimization) time and dates to multiple task information items by executing arrangement scheduling for lines based on results of sorting attribute values of attribute information assigned to the task Information items.

The “optimization” indicates either or both of the improvement of the efficiency of the switching task or the facilitation of the switching task and the assignment, satisfying a requirement such as a constraint on the production tasks or a request for the production tasks, of time and dates to production tasks. An example of the “requirement” is a reduction in the risk of color transfer in a task related to colored products.

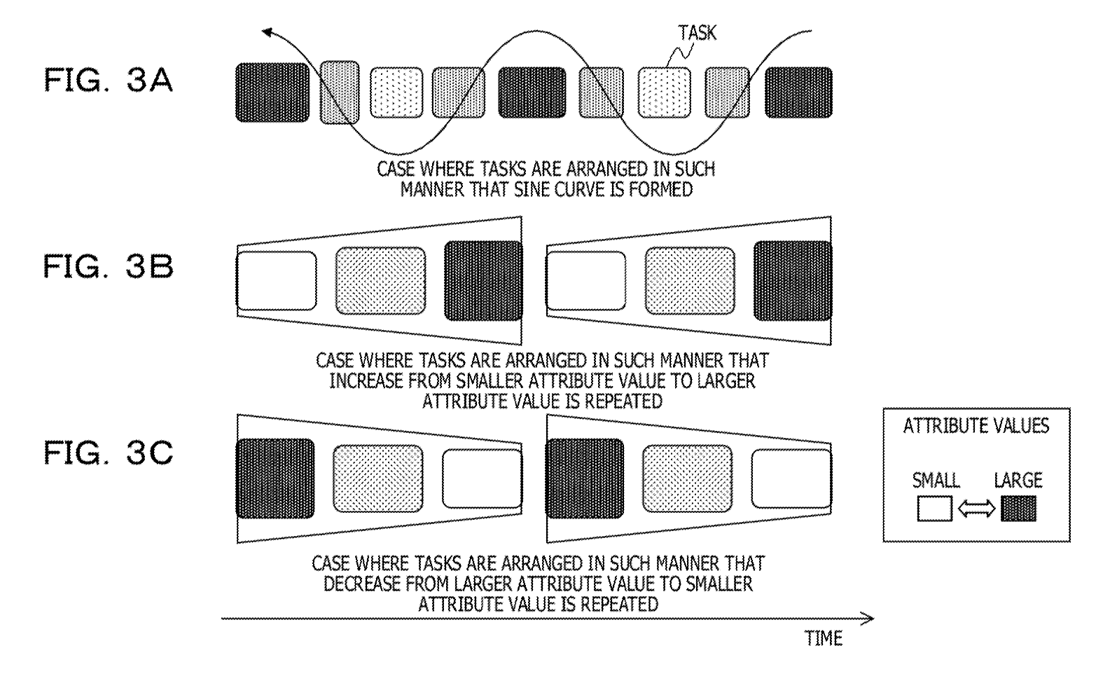

In the embodiment, the server 10 may execute order scheduling Illustrated in FIGS. 3A, 3B and 3C, for example. In FIGS. 3A, 3B and 3C, square blocks indicate tasks, the densities of hatched square blocks indicate the magnitude of attribute values (for example, heavily hatched blocks indicate that attribute values are large, and lightly hatched blocks indicate that attribute values are small). In addition, the abscissa Indicates time, for example, time and dates assigned to task information items.

FIG. 3A indicates an example of the case where order scheduling is executed in such a manner that attribute values form a sine curve. This order scheduling is effective in the case where the attribute values are information on the “temperatures”, Information on the “widths” among the “sizes”, or the like. This order scheduling may be applied in the case where the attribute information is information on the “color densities” or information on the “thicknesses” among the “sizes”.

In the case where a task that is heating by a kiln or the like and in which “temperatures” are used is executed, as temperatures to be used for preceding and succeeding products are closer to each other, the temperature of the kiln is more efficiently and more easily controlled in some cases. For example, the temperature of the kiln may be gently controlled by order scheduling that causes the repetition of a change in the temperature from a higher temperature to a lower temperature (or a change from a value Indicating the higher temperature to a value indicating the lower temperature) and a change from a lower temperature to a higher temperature (or a change from the value Indicating the lower temperature to the value indicating the higher temperature). It is, therefore, possible to reduce a time period for executing a switching task for controlling the temperature to a temperature suitable for a task and reduce the amount of a fuel to be used, the quantity of electricity to be used, or the like.

In addition, in the case where a task such as a task of processing products having different “widths” or the like on a line is executed, intervals between jigs such as rollers to be used to hold and transport target objects are adjusted based on the widths of the target objects. In this case, as the difference between the “widths” of preceding and succeeding products is smaller, the adjustment may be more efficiently executed. For example, the control of gently adjusting the intervals between the jigs such as the rollers may be executed by order scheduling that causes the repetition of a change from a value indicating a larger width (size) to a value indicating a smaller width (size) and a change from the value indicating the smaller width (size) to the value indicating the larger width (size). It is, therefore, possible to reduce a time period for executing a switching task.

In addition, FIG. 3B Indicates an example of the case where order scheduling is executed and causes a change from a smaller attribute value to a larger attribute value and repeats the change from the smaller attribute value to the larger attribute value. This order scheduling is effective in the case where the attribute information is information on the “color densities” or the like. The order scheduling indicated by FIG. 3B is also effective in the case where the attribute information is information on the “temperatures” or information on the “widths” among the “sizes” for the same reason as described above. This order scheduling may be applied in the case where the attribute information is information on the “thicknesses” among the “sizes”.

In the case where a task that is coloring or the like and in which “colors” are used is executed on a line, a task of switching between production tasks in the case where the production tasks are executed on products in the order from a dark color product to a light color product may be more efficiently and easily executed, compared with a task of switching between the production tasks in the case where the production tasks are executed on the products in the opposite order. This is due to the fact that, in the former case, cleaning is executed in the switching task in order to avoid color transfer to the dark color product, and in the latter case, an effect of color transfer to the dark color product is small and cleaning is not executed or is simplified in the switching task.

For example, since the cleaning of a line is omitted or simplified due to order scheduling that causes a change from a lower color density to a higher color density (or a change from a value indicating the lower color density to a value indicating the higher color density) and repeats this change, it is possible to reduce a time period for executing a task of switching between tasks and reduce the risk of color transfer.

In addition, a symbol (c) indicates an example of the case where order scheduling is executed and causes a change from a larger attribute value to a smaller attribute value and repeats the change from the larger attribute value to the smaller attribute value. This order scheduling is effective in the case where the attribute information is information on the “thicknesses” among the “sizes” or the like. The order scheduling indicated by the symbol (c) is also effective in the case where the attribute information is information on the “temperatures” or information on the “widths” among the “sizes” for the same reason as described above. This order scheduling may be applied in the case where the attribution information is information on the “color densities”.

In the case where a task such as a task of processing products having different “thicknesses” on a line is executed, cleaning (removal of scraps) of rollers and the like is executed in a task of switching between tasks, for example, but the cleaning may be omitted when a preceding product having a larger “thickness” is switched to a succeeding product having a smaller “thickness”. For example, the cleaning of the rollers and the like may be omitted due to order scheduling that causes a change from a larger thickness (size) to a smaller thickness (size) and repeats this change. Thus, the improvement of the efficiency of the switching task and the facilitation of the switching task may be achieved and a time period for the switching task may be reduced.

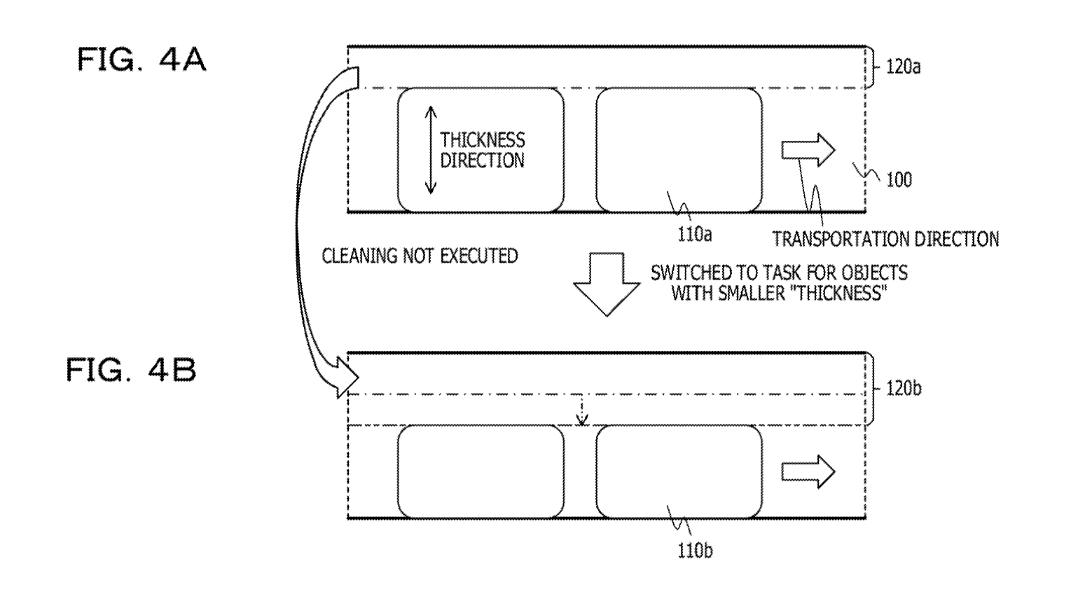

As an example, as indicated in FIG. 4A, when objects 110a targeted for tasks are transported along a side surface (surface on which rollers are installed) of a line, a scrap or the like may adhere to a region indicated by a symbol 120a. In this case, if a task is switched to another task in which objects 110b having a smaller “thickness” than the objects 110a are transported, the thicknesses of the objects 110b targeted for the other task are smaller than the thicknesses of the objects 110a targeted for the task, and a region 120b to which scraps or the like adhere is larger than the region 120a. Specifically, in a task of switching the task indicated in FIG. 4A to the other task indicated in FIG. 4B, the cleaning of the region indicated by the symbol 120a may be omitted.

The order scheduling that causes the sine curve in the case indicated by FIG. 3A may be treated as a combination of the order scheduling indicated by FIG. 3B and the order scheduling indicated by FIG. 3C. In other words, it may be said that the order scheduling that causes the sine curve is a process of assigning time and dates within a specific time period to multiple task information items in such a manner that a change from a larger attribute value to a smaller attribute value and a change from the smaller attribute value to the larger attribute value are repeated.

As described above, the server 10 according to the embodiment may flexibly assign time and dates to task information items or may assign time and dates to multiple task information items in such a manner that attribute values assigned to the task information items gradually change. Thus, the improvement of the efficiency of a switching task and the facilitation of the switching task may be achieved.

(Example of Functional Configuration)

Next, an example of a functional configuration of the server 10 is described.

As Illustrated in FIG. 1, the server 11 may exemplarily include a database (DB) 11, a memory section 12, an operation receiver 13, an output section 14, and a controller 15.

The DB 11 stores and manages various types of information to be used to generate the production plan or stores and manages, for example, master Information. For example, the DB 11 may store and manage stage information 11a, line resource information 11b, line production procedure information 11c, and product Information 11d.

The memory section 12 stores various types of information to be used to generate the production plan or stores, for example, transaction information. For example, the memory section 12 may store production plan information 12a and arrangement plan information 12b.

Each of the DB 11 and the memory section 12 may be achieved by a storage region of a portion or whole of the memory 10b of the server 10 illustrated in FIG. 2 or a storage region of a portion or whole of the storage section 10c of the server 10 illustrated in FIG. 2. Details of the information stored in the DB 11 and the memory section 12 are described later together with a description of an example of control by the controller 15.

The operation receiver 13 receives an access request from the terminal 20 and outputs, to the controller 15, an instruction based on the access request. Examples of the access request are various operation requests related to the arrangement of the production plan based on a screen displayed in the display device 22.

The output section 14 transmits the process results received from the controller 15 to the terminal 20. An example of the process results is screen information based on an operation request. Examples of the screen information are various types of information such as information of a chart, a graph, texts, and the like, and information that is a window or a tooltip and is related to screen control, various parameters, and control information.

The process results may include information on results of the generation of the task plan by the controller 15 or results of assigning tasks. This Information may be output to the terminal 20 and another system and may be referenced by the output destinations in the management, execution, and the like of the tasks.

The controller 15 controls the generation of the task plan by assigning time and dates to task information items based on the instruction from the operation receiver 13 and outputs the process results to the output section 14. The control may include control for various types of calculation related to the assignment of task information items, the generation and update of information such as a chart, a graph, texts, and the like that are displayed on a screen, and display control such as screen transition, screen control, and scale control.

The controller 15 may exemplarily include an extractor 15a and a calculator 15b.

In the assignment of time and dates within a specific time period to multiple task information items based on the instruction from the operation receiver 13, the extractor 15a extracts, for each of stages and each of lines, multiple task information items to which time and dates are to be assigned.

In the assignment of time and dates within a specific time period to multiple task information items, the calculator 15b references attribute information associated with the task information items, sorts the multiple task information items in such a manner that attribute values of the attribute information associated with the task information items change to larger attribute values or change to smaller attribute values, and assigns the time and dates to the task information items. The calculator 15b may execute the aforementioned assignment on the multiple task information items extracted by the extractor 15a.

The controller 15 executes the display control, and the results of assigning the time and dates to the task information items by the calculator 15b may be transmitted to the terminal 20 via the output section 14 as a response to the request from the terminal 20. The terminal 20 may display the assignment results in the display device 22 based on screen information included in the received response, for example.

### [1-2] Example of Control by Controller

Next, an example of the control by the controller 15 is described.

Upon receiving an instruction to generate the task plan from the operation receiver 13, the controller 15 executes a process related to control of assigning time and dates to task information items.

The generation instruction may include, for each of stages, information (parameter) of one or more types among an “arrangement pattern”, an “arrangement time period”, a “sort pattern”, and one or more “candidate priorities”.

The “arrangement pattern” is information indicating whether tasks are arranged based on attributes or other conditions. The “arrangement time period” is information indicating a time period in which the tasks are arranged or indicating, for example, the length of a divided time period obtained in a process (ii) described later.

The “sort pattern” indicates a sort pattern of an arrangement method specified in the arrangement pattern. If the arrangement pattern indicates an attribute sort, the “sort pattern” may indicate a pattern such as an “ascending sort”, a “descending sort”, a “sine curve”, or the like. The “candidate priority” is information serving as a key to be used in the sort or is, for example, information indicating the attributes. If the tasks are arranged based on attributes of multiple types, multiple “candidate priorities” may be included in the generation instruction.

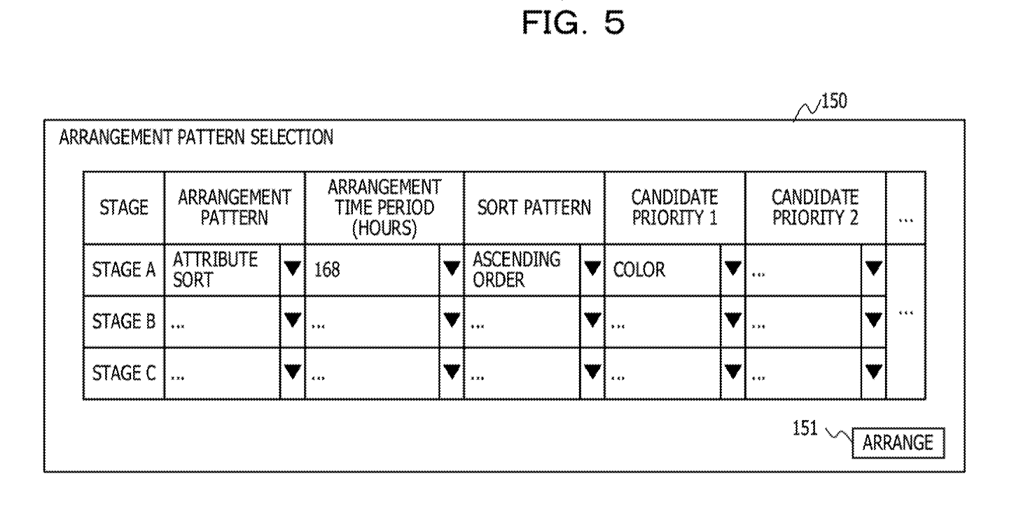

The aforementioned items included in the generation instruction may be specified by an operator on an arrangement pattern selection screen 150 displayed in the display device 22 of the terminal 20 via the input device 21 of the terminal 20, as illustrated in FIG. 5, for example. For example, when items of the arrangement pattern selection screen 150 are selected by an operation of the operator, and an Arrange button 151 is pressed, the terminal 20 may transmit a request including the selected items to the server 10. The operation receiver 13 of the server 10 may notify the generation instruction to the controller 15 based on the request received from the terminal 20.

The process to be executed by the controller 15 and related to the control of assigning time and dates to task information items may include the following processes (i) to (vi).

(i) The determination of the processing order of stages

(ii) The division of a plan time period for generating the task plan

(iii) The acquisition of tasks to be arranged within divided time periods

(iv) The assignment of the acquired tasks to lines

(v) The calculation of the order of the tasks based on attribute values

(vi) The arrangement of the tasks in the calculated order

These processes are described below.

(i) Determination of Processing Order of Stages

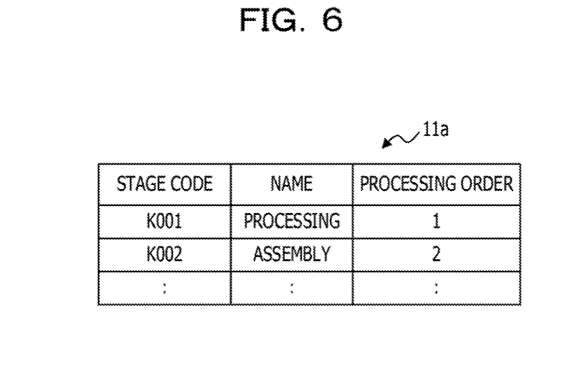

The controller 15 may determine the processing order of stages specified in the generation instruction based on the stage information 11a exemplified in FIG. 6. The processes (ii) to (vi) may be executed by the controller 15 for each of the stages in the determined processing order.

The stage information 11a is information to be used to manage the stages and may exemplarily include information of “stage codes”, “names”, and the “processing order”, as illustrated in FIG. 6.

(ii) Division of Plan Time Period for Generating Task Plan

The controller 15 may divide, into multiple time periods, the plan time period for generating the task plan, based on the “arrangement time periods” Included in the generation instruction. The divided time periods are the lengths of the “arrangement time periods” and are time periods for process units of the processes (iii) to (vi). For example, the controller 15 may divide, into the arrangement time periods, a time period from a predetermined date (for example, a start day of week that is specified by default) before the start date of the plan time period to the end date of the plan time period.

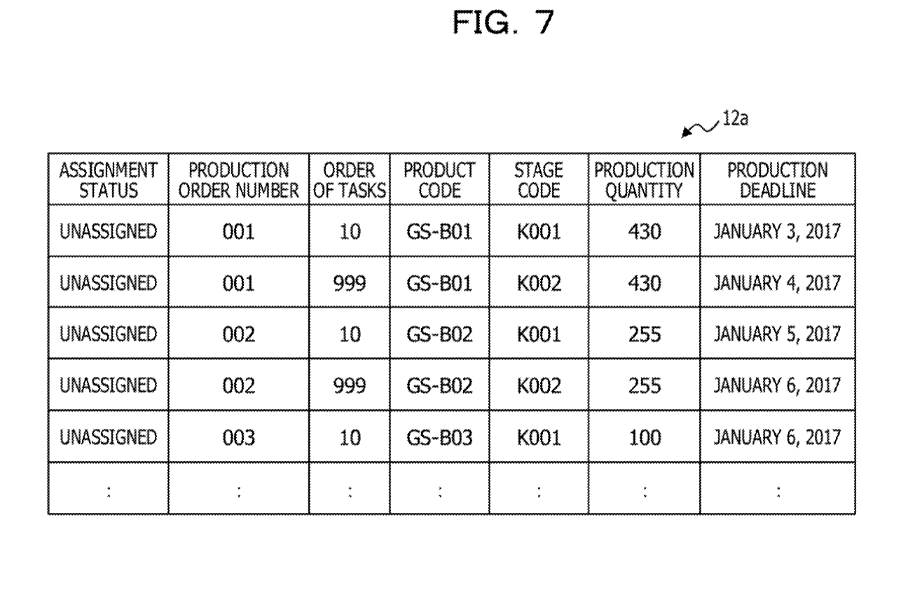

The “plan time period” may be a time period in which production deadlines of tasks included in a task list indicating the target tasks of the task plan are distributed. The production deadlines of the tasks may be managed using the production plan Information 12a illustrated in FIG. 7.

The production plan information 12a is information to be used to manage the production plan of the products or components. Entries may be added to the production plan information 12a based on an instruction (production order) to produce the products or components from the operator, another system, or the like. The production plan information 12a may exemplarily include “assignment statuses”, “production order numbers”, the “order of tasks”, “product codes”, “stage codes”, “production quantities”, and “production deadlines” that are an example of deadlines, as illustrated in FIG. 7. The “order of the tasks” Is Information Indicating the order of the tasks. For example, as the value of the order that a task is executed is smaller, the task is executed at earlier time.

In the embodiment, a “task information item” may indicate information of one entry included in the production plan information 12a, for example. The “assignment of time and a date to a task information item” may include a series of processes (or a part of the processes) of executing the aforementioned processes (i) to (vi) to assign the time and date when a line is used for a task Indicated in a certain entry included in the production plan information 12a and setting an “assignment status” to “assigned”. A “task information item” may be merely referred to as “task”.

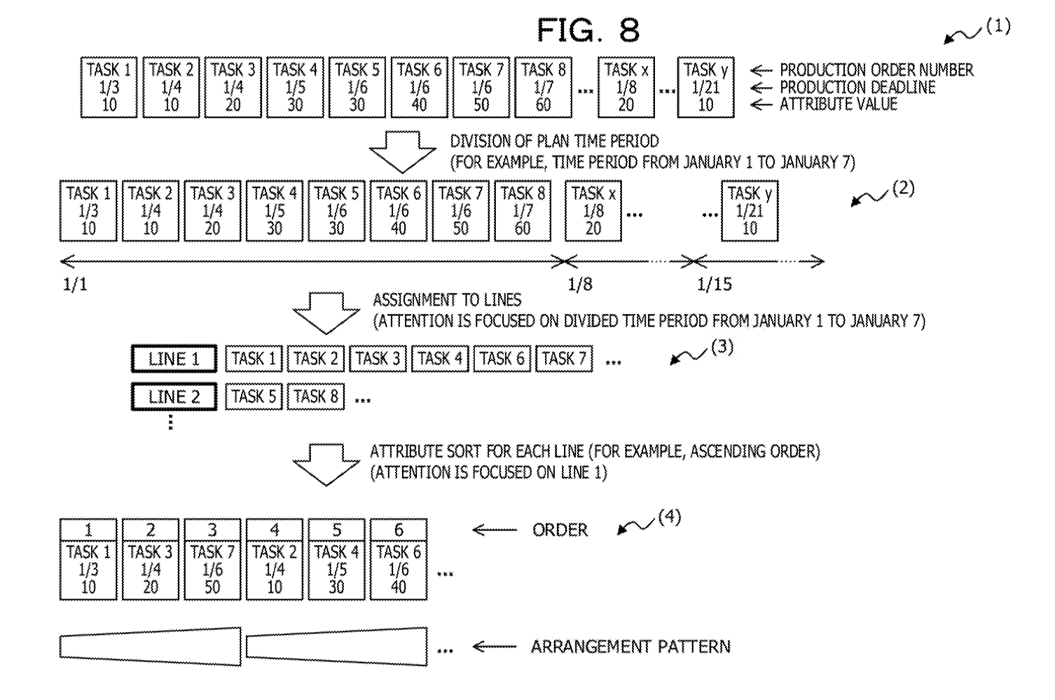

Hereinafter, an example of the division of the plan time period in the aforementioned process (ii) is described with reference to FIG. 8. FIG. 8 is a diagram illustrating an example of the aforementioned processes (ii) to (vi).

As exemplified by a symbol (1) in FIG. 8, if tasks from a “task 1” for which a production deadline is “January 3” to a “task y” for which a production deadline is “January 21” are included in the production plan information 12a, the plan time period is from “January 3” to “January 21”.

If “7 days” (or “168 hours”) are specified as an “arrangement time period”, the controller 15 divides the plan time period from “January 1” (Sunday) to “January 21” into time periods of “7 days”. The example illustrated in FIG. 8 assumes that the predetermined date is Sunday. Thus, as the divided time periods, a time period from “January 1” to “January 7”, a time period from “January 8” to “January 14”, and a time period from “January 15” to “January 21” are obtained (refer to a symbol (2)).

(iii) Acquisition of Tasks Arranged in Divided Time Periods

The controller 15 may acquire, based on the production plan information 12a illustrated in FIG. 7, tasks to be arranged in each of the divided time periods. For example, the controller 15 may determine, for each of entries of the production plan information 12a, whether or not a production deadline is included in any of the divided time periods, and acquire the tasks to be arranged in each of the divided time periods.

As an example, as indicated by the symbol (2) in FIG. 8, the controller 15 acquires, as tasks to be arranged in the divided time period from “January 1” to “January 7”, “tasks 1 to 8” within the divided time period including a production deadline. In addition, the controller 15 acquires, as tasks to be arranged in the divided time period from “January 8” to “January 14”, a “task x” and the like that are within the divided time period including a production deadline. Furthermore, the controller 15 acquires, as tasks to be arranged in the divided time period from “January 15” to “January 21”, a “task y” and the like that are within the divided time period including a production deadline.

(iv) Assignment of Acquired Tasks to Lines

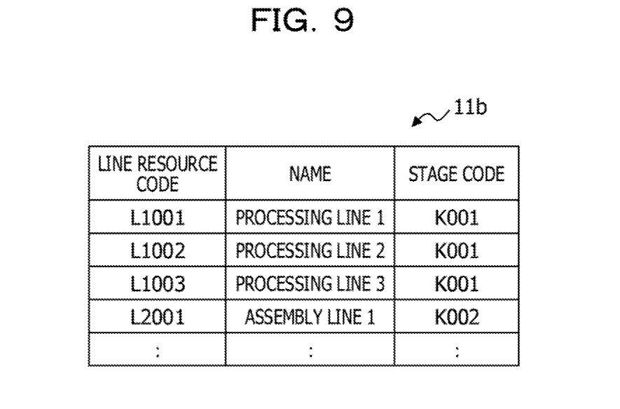

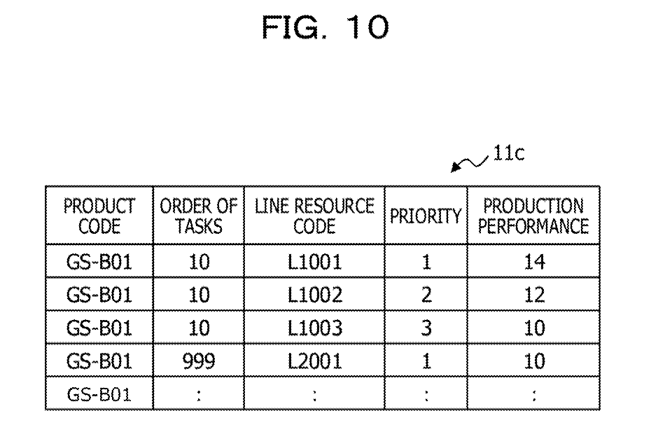

The extractor 15a of the controller 15 may assign, for each of the divided time periods, the tasks (tasks acquired in the aforementioned process (iii)) to be arranged in the divided time period to lines. The assignment of the aforementioned process (iv) may be executed based on the stage information 11a illustrated in FIG. 6, the line resource information 11b illustrated in FIG. 9, and the line production procedure information 11c illustrated in FIG. 10, for example.

The line resource information 11b is information to be used to manage line resources and may exemplarily include “line resource codes”, “names”, and “stage codes”, as Illustrated in FIG. 9.

The line production procedure information 11c is information to be used to manage a production procedure for a line for each of products and may exemplarily include “production codes”, the “order of tasks”, “line resource codes”, “priorities”, and “production performance”, as illustrated in FIG. 10. The “priorities” indicate usage priorities of line resources in the case where tasks that are executed on the same products in the same order are able to be executed with any of the multiple line resources. The “production performance” Indicates the number of components to be produced per minute for each of the line resources, for example.

For example, in the processes (ii) to (vi) related to a stage of “processing” with a stage code “K001” indicated in the stage information 11a Illustrated in FIG. 6, the extractor 15a references the line resource information 11b illustrated in FIG. 9 and acquires lines for which the stage code is “K001”. In this case, “processing lines 1 to 3” of “line resource codes L1001 to L1003” are acquired. Subsequently, the extractor 15a references the line production procedure information 11c illustrated in FIG. 10 and acquires priorities associated with the line resource codes acquired from the line resource information 11b. For example, the priorities “1” to “3” are acquired for the line resource codes “L1001” to “L1003”, respectively.

Then, the extractor 15a assigns (classifies) the tasks to be arranged in the target divided time period to any of the “processing lines 1 to 3” based on the acquired priorities. For example, the extractor 15a may prioritize lines with a high priority (whose value is small) and assign multiple tasks to the multiple lines based on the length of the divided time period (arrangement time period) and time periods for executing the tasks. The assignment of the tasks to the lines may be executed based on constraints on a line (in which a task is not able to be arranged) and the like that do not support a specific task, for example.

The extractor 15a may calculate the time periods for executing the tasks by dividing, for each of the tasks to be arranged in the target divided time period, a production quantity indicated in the production plan information 12a by production performance indicated in the line production procedure information 11c, for example. The assignment of tasks to a line with the highest priority is executed until the total of time periods for executing tasks assigned to the line exceeds the length of a divided time period (arrangement time period). A task that causes the total of time periods for executing tasks assigned to the line to exceed the length of the divided time period may be assigned to a line with the next highest priority.

As an example, when attention is focused on the divided time period from “January 1” to “January 7” that is illustrated in FIG. 8, the extractor 15a may assign the “task 1”, the “task 2”, the “task 3”, the “task 4”, the “task 6”, the “task 7”, and the like to the “line 1”, as indicated by a symbol (3). In addition, the extractor 15a may assign the “task 5”, the “task 8”, and the like to the “line 2”.

If lines prioritized for tasks are specified, the extractor 15a may assign the tasks to the lines in accordance with the specification of the lines, instead of or as well as the aforementioned method.

Although the arrangement of production tasks that is executed in the aforementioned method is described, the assignment of tasks to lines may be executed based on also a time period for executing a task of switching between tasks. The time period for executing the switching task may be managed using the master information (not illustrated) or the like, for example.

As described above, the extractor 15a is an example of a processing section that associates, for each of production lines with production performance set thereto, multiple task information items to the production line based on the production performance of the production line and production quantities associated with the task information items.

(v) Calculation of Order of Tasks Based on Attribute Values

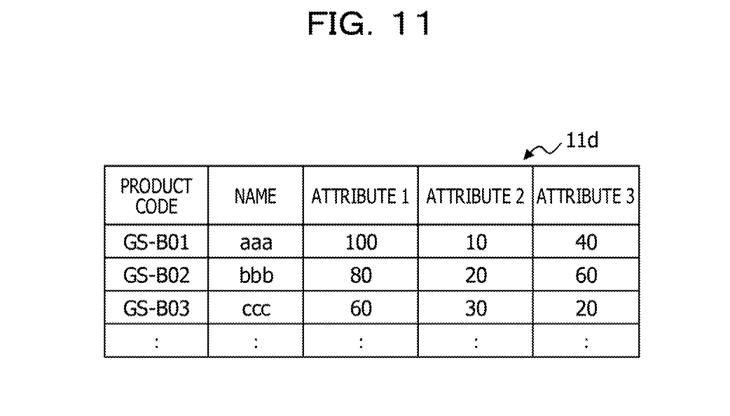

The calculator 15b of the controller 15 may calculate, based on the product information 11d illustrated in FIG. 11, the order of tasks based on attribute values for each of lines to which tasks have been assigned.

The product information 11d is information to be used to manage products related to tasks and may exemplarily include “product codes”, “names”, and one or more “attributes”, as illustrated in FIG. 11. The “attributes” (“attributes 1 to 3” in the example illustrated in FIG. 11) are an example of attribute information on products or tasks and may be, for example, information such as “colors”, “temperature zones” (or “temperatures”), or “sizes” (for example, “widths”, “thicknesses”, or the like). In items of the “attributes” included in entries of the product Information 11d, attribute values of the “attributes” may be set. In the items of the “attributes”, the values (for example, temperatures or sizes) of the “attributes” may be set or information obtained by converting the “degrees” of the attributes into comparable numerical values, characteristic strings, or the like may be set. An example of the latter information is information obtained by converting the “colors” into numerical values, color codes, or the like.

For example, the calculator 15b may sort tasks based on the attribute values, associated with one or more “candidate priorities” specified in the generation instruction, of the “attributes” of the product information 11d in such a manner that the sorted tasks are arranged in order corresponding to a “sort pattern” specified in the generation instruction.

As an example, when attention is focused on the “line 1” illustrated in FIG. 8, the calculator 15b may sort tasks within the line in such a manner that the “task 1”, the “task 3”, the “task 7”, the “task 2”, the “task 4”, the “task 6”, and the like are arranged in this order, as indicated by a symbol (4). In the example illustrated in FIG. 8, attribute values “10”, “20”, “50”, “10”, “30”, “40”, and the like of the attributes of the tasks are arranged in this order and repeatedly change from a smaller attribute value to a larger attribute value (refer to the symbol (b)), as exemplified in FIG. 3.

(vi) Arrangement of Tasks in Calculated Order

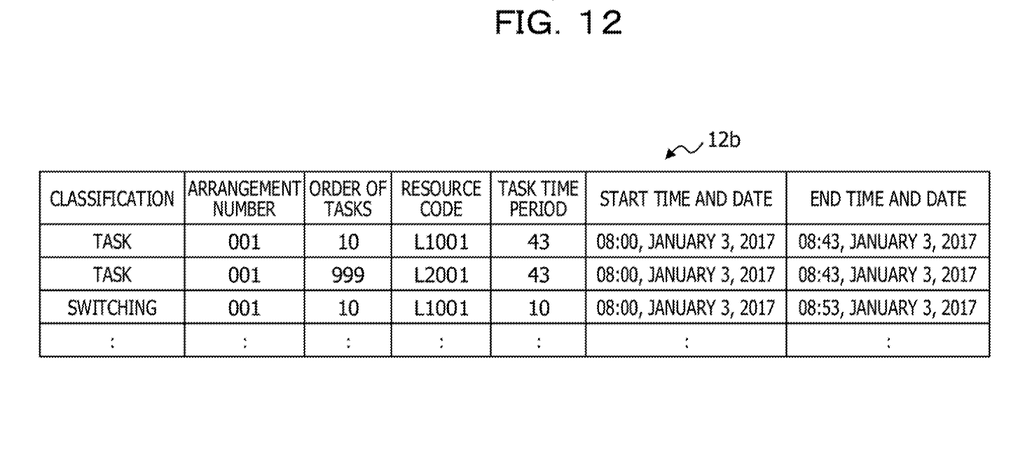

The calculator 15b may assign time and dates to task information items in such a manner that tasks are arranged in the order calculated in the aforementioned process (v). For example, the calculator 15b may assign the time and dates to the task information items by registering information of the tasks (production tasks) and the switching (switching task) in the arrangement plan information 12b illustrated in FIG. 12 and updating “assignment statuses” of the production plan information 12a illustrated in FIG. 7 to “assigned”.

The arrangement plan information 12b is Information to be used to manage a plan of arranging assigned tasks and may exemplarily include information of “classifications”, “arrangement numbers”, the “order of tasks”, “resource codes”, “task time periods”, “start time and dates”, and “end time and dates”. The “arrangement numbers” are information indicating production orders and may be referred to as “production order numbers”. The “resource codes” are identification information of line resources and may be referred to as “line resource codes”.

The “start time and dates” and the “end time and dates” are the start and end time and dates assigned to the tasks. In other words, the “start time and dates” and the “end time and dates” Indicate time periods for which lines are used for the assigned tasks. The “end time and dates” may be obtained by adding the “task time periods” to time and dates (corresponding to the “start time”) when the tasks are assigned.

The “task time periods” may be calculated based on the “production quantities” indicated in the production plan information 12a and the “production performance” indicated in the line production procedure information 11c illustrated in FIG. 10, as described above. The controller 15 may cause the task time periods calculated in the aforementioned process (iv) to be stored in a storage region of the memory section 12 in order to set the task time periods in the arrangement plan information 12b, for example.

An entry of a switching task may be registered in the arrangement plan information 12b based on the master information (not illustrated) to be used to manage the time period for executing the switching task, for example.

As described above, the calculator 15b is an example of an assigning section that references attribute values associated with task information items and assigns time and dates within a specific time period to the multiple task information items in such a manner that the attribute values associated with the task information items change from larger attribute values to smaller attribute values or change from smaller attribute values to larger attribute values.

In addition, it may be said that the calculator 15b as the example of the assigning section assigns, for each of production lines, time and dates within a specific time period to multiple task information items associated with the production line acquired by the extractor 15a.

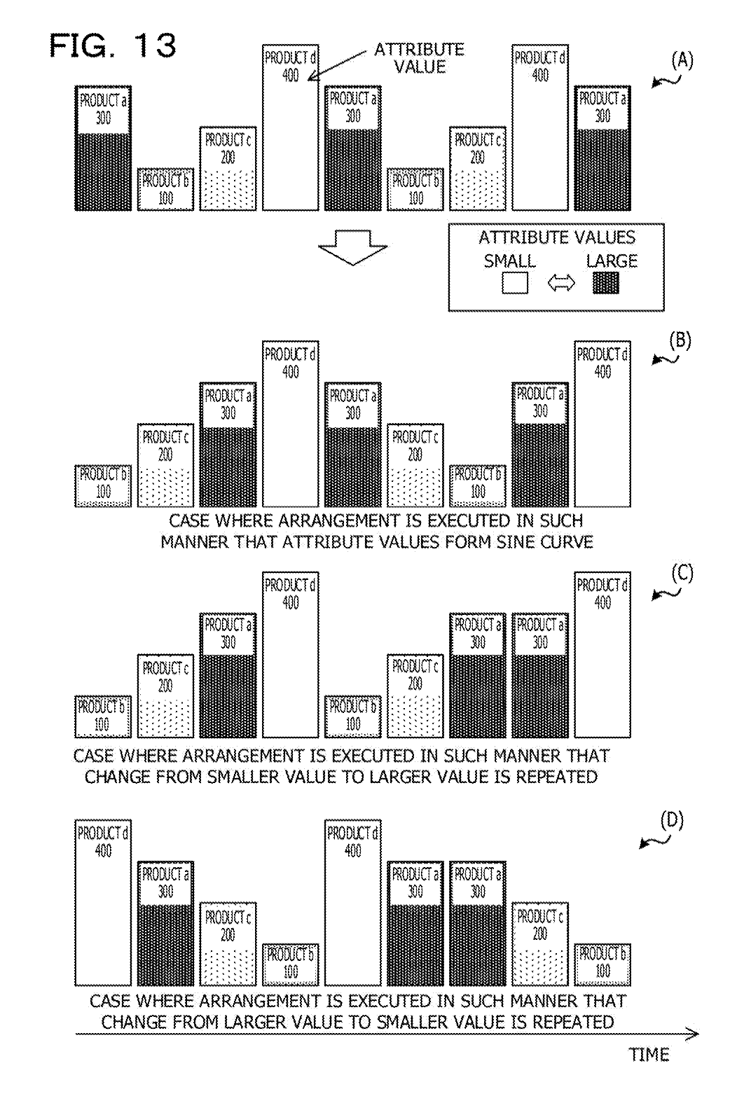

The production plan may be generated by the aforementioned processes (i) to (vi). By executing the aforementioned processes, the controller may assign time and dates to tasks in such a manner that the tasks are arranged in various types of order based on “sort patterns” specified in the generation instruction, as exemplified in FIG. 13.

For example, if the “sort patterns” are the “sine curve”, the “ascending order”, and the “descending order” for multiple tasks for multiple products a to d indicated by a symbol (A) In FIG. 13, the controller 15 may arrange the tasks in order indicated by symbols (B), (C), and (D).

### [1-3] Example of Operations

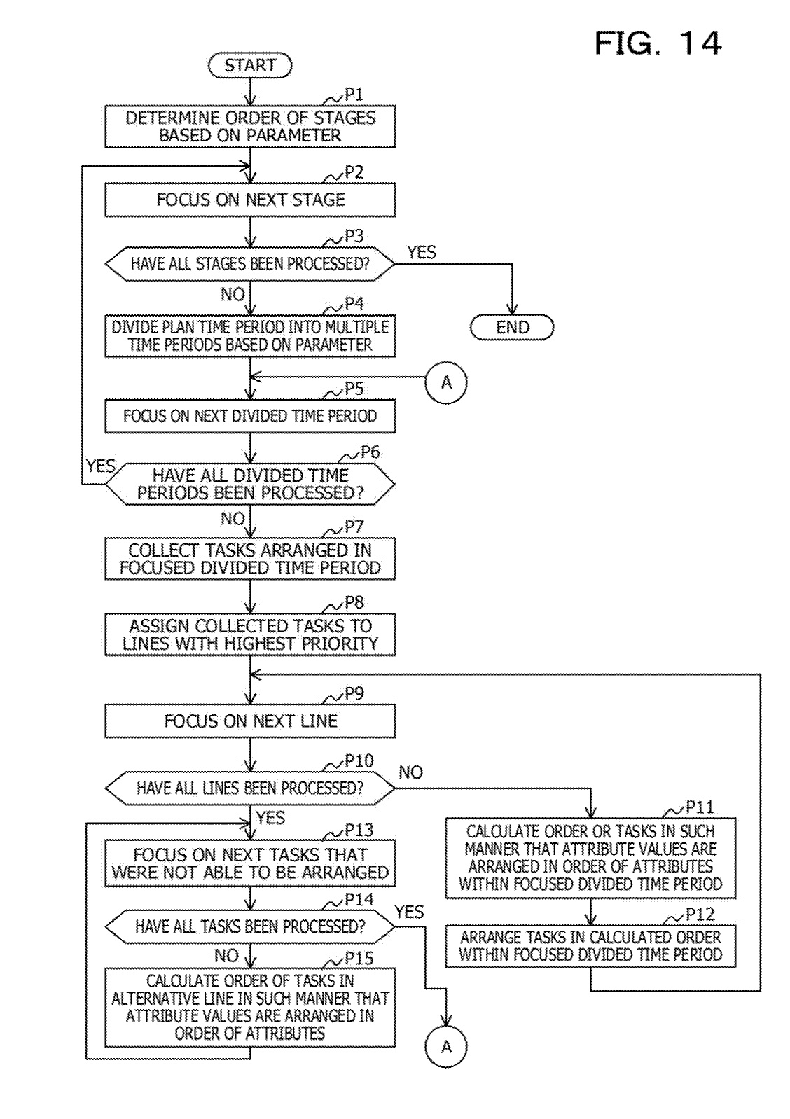

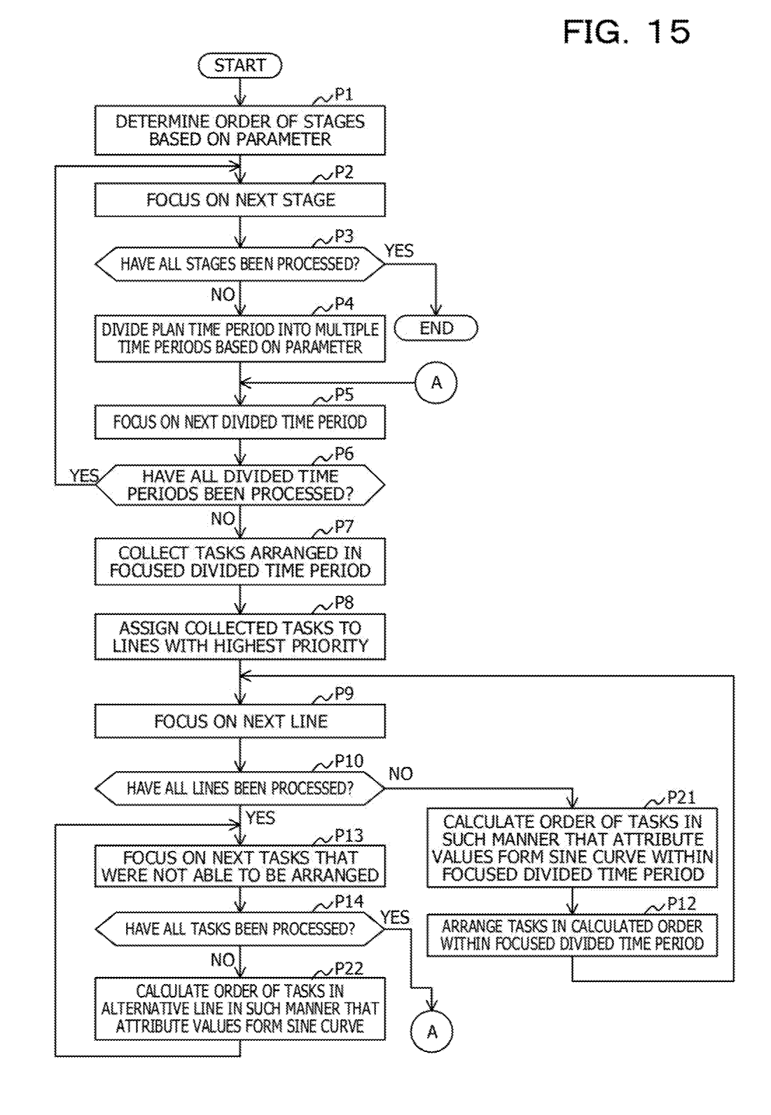

Next, an example of operations of the server 10 included in the system 10 configured as described above is described with reference to FIGS. 14 and 15.

(Case where Order Scheduling is Executed to Arrange Attribute Values in Order of Attributes)

FIG. 14 is a flowchart of an example of operations of the server 10 in the case where order scheduling is executed to arrange attribute values in the order (in which, for example, the ascending order or the descending order is repeated) of attributes.

As illustrated in FIG. 14, upon receiving, from the operation receiver 13, a generation instruction transmitted from the terminal 20 and based on a request to generate a production plan, the controller 15 of the server 10 determines, based on a parameter included in the generation instruction, the processing order of stages of generating the production plan (in step P1).

Next, the controller 15 focuses on the next stage (first stage in the case where a process is initially executed) in the processing order of the stages (in step P2) and determines whether or not all the stages have been processed (in step P3). If all the stages have been processed (Yes in step P3), the process is terminated.

On the other hand, if one or more of all the stages has not been processed (No in step P3), the controller 15 divides a plan time period into multiple time periods based on the parameter (in step P4).

Then, the controller 15 focuses on the next divided time period (in step P5). In step P5, the controller 15 may focus on the divided time periods in order from the earliest divided time period in forward arrangement or may focus on the divided time periods in order from the latest divided time period in backward arrangement. Then, the controller 15 determines whether or not all the divided time periods have been processed (in step P6). If all the divided time periods have been processed (Yes in step P6), the process proceeds to step P2.

On the other hand, if one or more of all the divided time periods has not been processed (No in step P6), the extractor 15a of the controller 15 collects tasks arranged in the focused divided time period (in step P7). In step P7, the extractor 15a may determine the tasks arranged in the focused divided time period, based on a production deadline or the time difference between the focused stage and a preceding or succeeding stage for which tasks have been arranged. Then, the extractor 15a assigns the collected tasks to lines with the highest priority (in step P8).

Then, the calculator 15b of the controller 15 focuses on the next line within the divided time period (in step P9). In step P9, the calculator 15b may select the next line in descending order of the number of tasks assigned to each of the lines after the assignment of step P8. Then, the calculator 15b determines whether or not all the lines have been processed (in step P10).

If one or more of all the lines has not been processed (No in step P10), the calculator 15b calculates the order of the tasks in such a manner that attribute values are arranged in the order of attributes within the focused divided time period (in step P11). Then, the calculator 15b arranges the multiple tasks in the calculated order within the focused divided time period (in step P12), and the process returns to step P9.

On the other hand, if all the lines have been processed (Yes in step P10), the calculator 15b focuses on next tasks (first task in the case where step P13 is initially executed) that were not able to be arranged in the lines (in step P13), and the calculator 15b determines whether or not all the next tasks that were not able to be arranged in the lines have been processed (in step P14). If all the next tasks that were not able to be arranged in the lines have been processed (Yes in step P14), the process returns to step P5.

If one or more of all the next tasks that were not able to be arranged in the lines has not been processed (No in step P14), the calculator 15b calculates the order of tasks in an alternative line or, for example, a line with the next highest priority in such a manner that attribute values are arranged in the order of attributes within the focused divided time period (in step P15). Then, the process returns to step P13.

(Case where Order Scheduling is Executed to Cause Attribute Values to Form Sine Curve)

FIG. 15 is a flowchart of an example of operations of the server 10 in the case where order scheduling is executed to cause attribute values to form a sine curve. Steps P1 to P10 illustrated in FIG. 15 and steps P12 to P14 Illustrated in FIG. 15 are the same as or similar to those illustrated in FIG. 14, and a description of those processes is omitted.

As illustrated in FIG. 15, if the answer is No in step P10, the calculator 15b of the controller 15 calculates the order of the tasks in such a manner that the attribute values form a sine curve within the focused divided time period (in step P21). Then, the process proceeds to step P12.

In addition, if the answer is No in step P14, the calculator 15b calculates the order of the tasks in the alternative line or the line with the next highest priority in such a manner that the attribute values form a sine curve (in step P22). Then, the process returns to step P13.

### [1-4] Modified Example

The embodiment describes the method of flexibly assigning time and dates to multiple task information items in such a manner that attribute values assigned to the task information items gradually change and achieving the improvement of the efficiency of the switching task and the facilitation of the switching task.

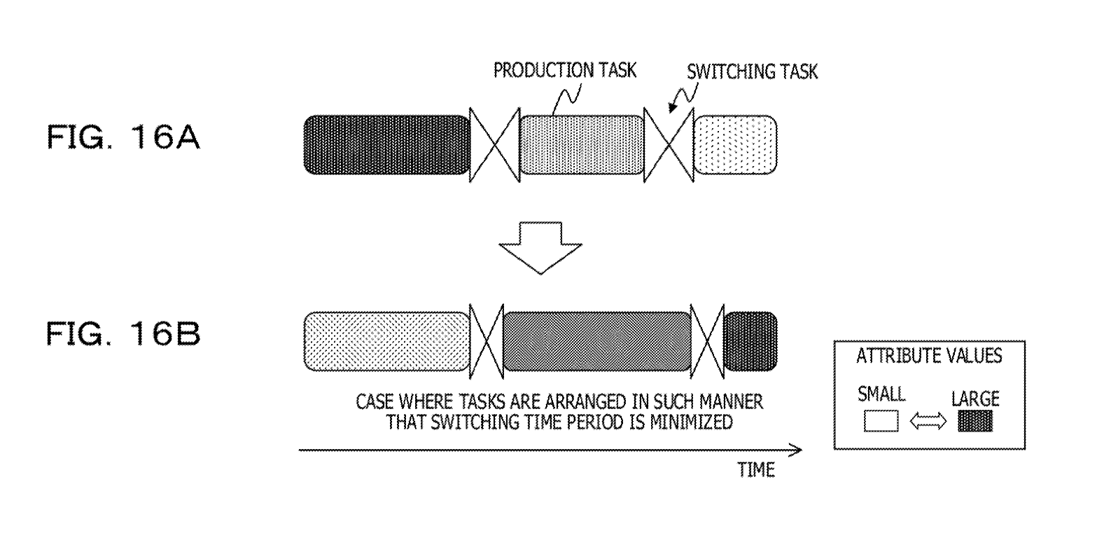

For example, as indicated in FIGS. 16A and 16B, time periods (switching time periods) for executing tasks of switching between production tasks may be reduced depending on combinations of preceding and succeeding production tasks. As one of factors that cause the reductions in the switching time periods, a part or whole of the switching tasks may be omitted by the attribute sort according to the embodiment.

In a modified example, attention is focused on combinations of preceding and succeeding production tasks and switching time periods are reduced by assigning time and dates to multiple task information items based on switching tasks as another example of attributes associated with combinations of multiple task information items, as indicated in FIG. 16B. In the following description, processes that are to be executed by the server 10 according to the modified example and are not specifically mentioned are the same as or similar to those to be executed by the server 10 according to the embodiment.

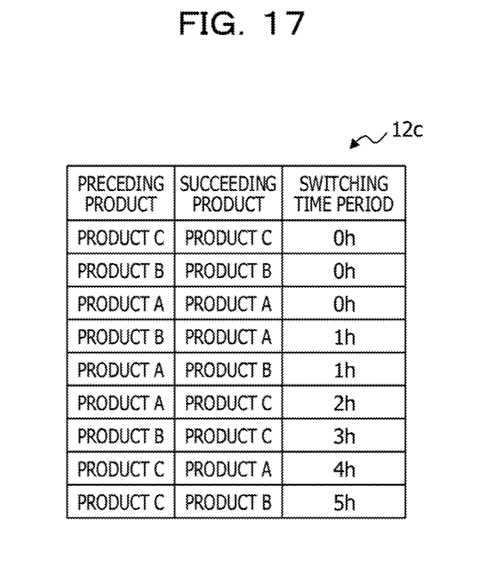

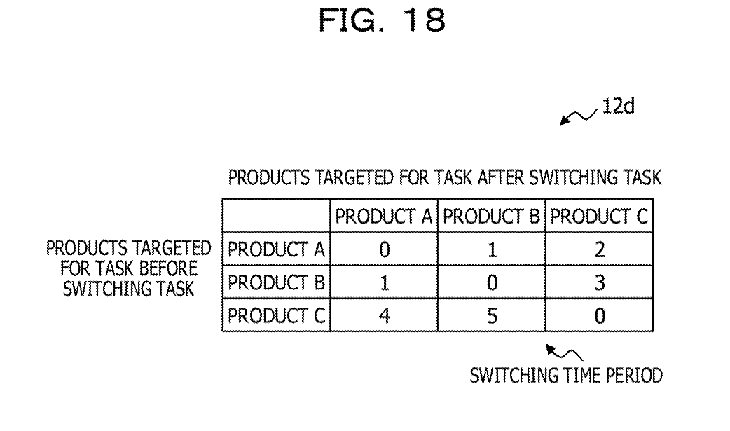

The controller 15 according to the modified example may generate relationship information of the switching time periods related to products preceding and succeeding all products related to tasks targeted for processes or acquire the relationship information from a database. As the relationship information, either or both of switching time period information 12c Illustrated in FIG. 17 and a switching matrix 12d illustrated in FIG. 18 may be used. The switching time period information 12c and the switching matrix 12d may be stored in the memory section 12 (or the DB 11), for example.

In the aforementioned process (v) according to the embodiment, the calculator 15b may calculate, based on either or both of the switching time period information 12c and the switching matrix 12d, the order of the multiple tasks assigned to lines in such a manner that the switching time periods are minimized within divided time periods.

In other words, it may be said that the calculator 15b arranges the multiple tasks in order and assign time and dates to the multiple tasks in such a manner that a value obtained by summing the total value of time periods for executing the multiple tasks and the total value of the switching time periods associated with combinations of tasks preceding and succeeding the multiple tasks in the order is minimized.

As described above, the switching time periods may be reduced by the attribute sort according to the embodiment. In this case, results, obtained by the processes executed by the server 10 according to the modified example, of arranging tasks based on the switching time periods may match or substantially match results, obtained by the processes executed by the server 10 according to the embodiment, of arranging the tasks based on the attribute sort.

For example, if temperature zones are used as attributes, arranging tasks in such a manner that temperatures form a sine curve leads to reductions in time periods for executing switching tasks in order to control the temperatures to temperatures suitable for the tasks. In addition, in a line on which tasks are executed based on temperature zones, the minimization of switching time periods may cause temperatures to gradually change or may cause, for example, tasks to be arranged in such a manner that the temperatures form a sine curve.

Thus, according to an aspect, processes of the server 10 according to the modified example may be considered as processes obtained by changing a process of the attribute sort by the server 10 according to the embodiment to a process of minimizing a switching time period.

Whether the server 10 executes the operations according to the embodiment or executes the operations according to the modified example may be specified by an “arrangement pattern” included in the generation instruction, for example.

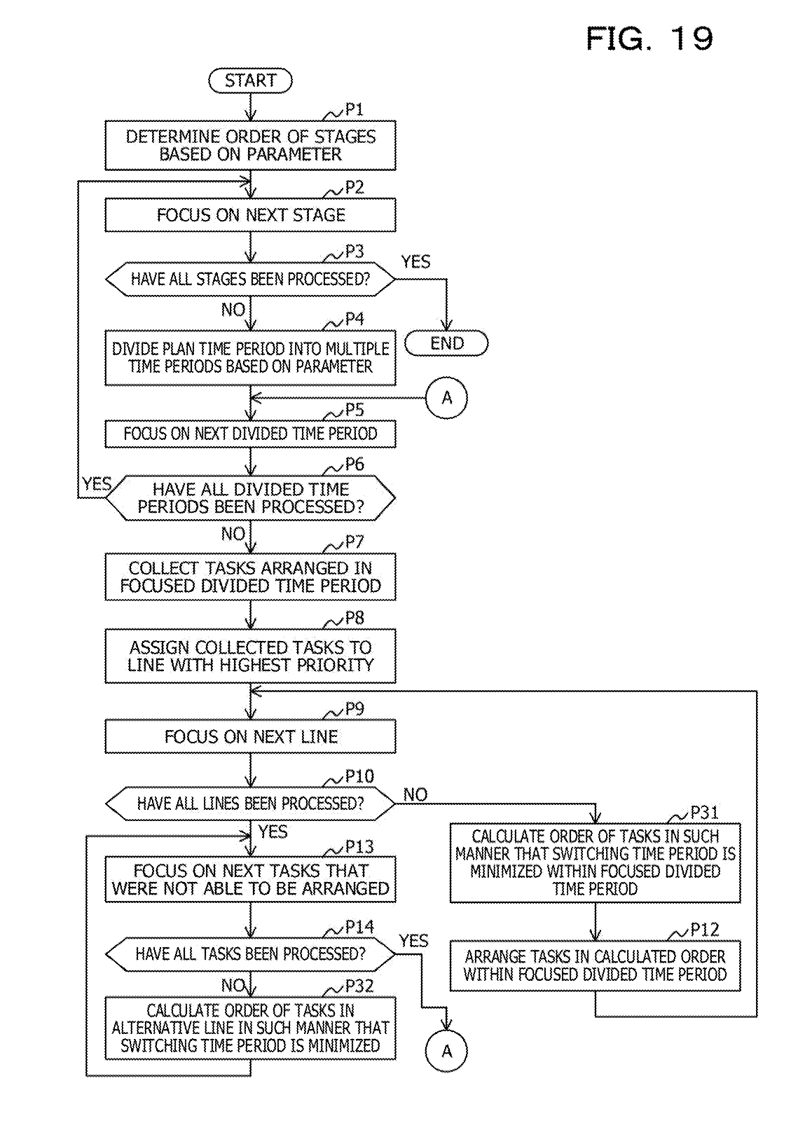

FIG. 19 is a flowchart of an example of the operations of the server according to the modified example. Steps P1 to P10 Illustrated in FIG. 19 and steps P12 to P14 illustrated in FIG. 19 are the same as or similar to those illustrated in FIGS. 14 and 15, and a description of those processes is omitted.

As illustrated in FIG. 19, if the answer is No in step P10, the calculator 15b of the controller 15 calculates the order of the tasks in such a manner that a switching time period is minimized within the focused divided time period (in step P31). Then, a process proceeds to step P12.

If the answer is No in step P14, the calculator 15b calculates the order of the tasks in the line with the next highest priority in such a manner that a switching time period is minimized within the focused divided time period (in step P32). Then, the process returns to step P13.

Even in the modified example of the embodiment, the controller 15 may flexibly assign time and dates to multiple task information items by determining the order of task information items in such a manner that a time period for executing a switching task is minimized, and the improvement of the efficiency of the switching task and the facilitation of the switching task may be achieved. It is, therefore, possible to improve the efficiency of production and reduce a task load.

In addition, the server 10 may determine (or execute partial optimization) the order of task information items in consideration of production deadlines, divided time periods, constraints on lines, and the like in a state in which certain requirements are narrowed down. It is, therefore, possible to reduce a process load of the server 10, compared with the case where the order of task information items in the entire plan time period is collectively determined.

### [2] Others

The techniques according to the aforementioned embodiment may be modified and changed as follows.

The functional blocks included in the server 10 illustrated in FIG. 1 may be variously combined or divided.

In addition, the functions of the server 10 may be achieved by a multiprocessor or the multicore processor 10a.

Furthermore, the results of the processes executed by the controller 15 may be exported as data. As an example, the output section 14 or the controller 15 may have a function of exporting a graph such as a chart based on the generated task plan in response to a specific request from the terminal 20. Alternatively, the output section 14 or the controller 15 may have a function of exporting, as a file such as a comma-separated values (CSV) file, information on the generated task plan in response to the specific request.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method of generating a task plan that defines a plurality of execution times of a plurality of tasks by using a computer, the method comprising:
acquiring attribute information indicating a plurality of attributes of the plurality of tasks when the task plan is generated so that the plurality of tasks are executed within a first time period; and
executing, based on the acquired attribute information, a determination process that determines the plurality of execution times of the plurality of tasks so that a plurality of attribute values of the plurality of attributes of the plurality of tasks increase or decrease as time passes within the first time period.

2. The method according to claim 1, wherein
in the determination process, the task plan is determined so that the plurality of attribute values increase and decrease in a repetitive manner within the first time period.

3. The method according to claim 1, wherein
the attribute information is information on temperatures, and
the plurality of attribute values indicate the temperatures.

4. The method according to claim 1, wherein
the attribute information is information on sizes, and
the plurality of attribute values indicate the sizes.

5. The method according to claim 1, wherein
the attribute information is information on color densities, and
the plurality of attribute values indicate the color densities.

6. The method according to claim 1, wherein
based on production performance of a plurality of production lines and quantities of products to be produced by the plurality of tasks, the plurality of tasks are assigned to the production lines, and
the execution times of the plurality of tasks within the first time period is determined for each of the plurality of production lines.

7. An information processing apparatus configured to generate a task plan that defines a plurality of execution times of a plurality of tasks, the information processing apparatus comprising:
a memory; and
a processor coupled to the memory and configured to:
acquire attribute information indicating a plurality of attributes of the plurality of tasks when the task plan is generated so that the plurality of tasks are executed within a first time period, and
execute, based on the acquired attribute information, a determination process that determines the plurality of execution times of the plurality of tasks so that a plurality of attribute values of the plurality of attributes of the plurality of tasks increase or decrease as time passes within the first time period.

8. The information processing apparatus according to claim 7, wherein
in the determination process, the task plan is determined so that the plurality of attribute values increase and decrease in a repetitive manner within the first time period.

9. The information processing apparatus according to claim 7, wherein
the attribute information is information on temperatures, and
the plurality of attribute values indicate the temperatures.

10. The information processing apparatus according to claim 7, wherein
the attribute information is information on sizes, and
the plurality of attribute values indicate the sizes.

11. The Information processing apparatus according to claim 7, wherein
the attribute information is information on color densities, and
the plurality of attribute values indicate the color densities.

12. The information processing apparatus according to claim 7, wherein
based on production performance of a plurality of production lines and quantities of products to be produced by the plurality of tasks, the plurality of tasks are assigned to the production lines, and
the execution times of the plurality of tasks within the first time period is determined for each of the plurality of production lines.

13. A non-transitory computer-readable storage medium storing a program that causes an information processing apparatus to execute a process to generate a task plan that defines a plurality of execution times of a plurality of tasks, the process comprising:
acquiring attribute information indicating a plurality of attributes of the plurality of tasks when the task plan is generated so that the plurality of tasks are executed within a first time period; and
executing, based on the acquired attribute Information, a determination process that determines the plurality of execution times of the plurality of tasks so that a plurality of attribute values of the plurality of attributes of the plurality of tasks increase or decrease as time passes within the first time period.

14. The non-transitory computer-readable storage medium according to claim 13, wherein
in the determination process, the task plan is determined so that the plurality of attribute values increase and decrease in a repetitive manner within the first time period.

15. The non-transitory computer-readable storage medium according to claim 13, wherein
the attribute information is information on temperatures, and
the plurality of attribute values indicate the temperatures.

16. The non-transitory computer-readable storage medium according to claim 13, wherein
the attribute information is information on sizes, and
the plurality of attribute values indicate the sizes.

17. The non-transitory computer-readable storage medium according to claim 13, wherein
the attribute information is information on color densities, and
the plurality of attribute values indicate the color densities.

18. The non-transitory computer-readable storage medium according to claim 13, wherein
based on production performance of a plurality of production lines and quantities of products to be produced by the plurality of tasks, the plurality of tasks are assigned to the production lines, and
the execution times of the plurality of tasks within the first time period is determined for each of the plurality of production lines.
